(19) United States
(12) Patent Application Publication
(10) Pub. No.: US 2003/0235346 A1
(43) Pub. Date: Dec. 25, 2003

(54) Automatic measurement method for an auto-collimator

(76) Inventors: Han-chao Chen, Taipei (TW); Jeng-Jiun Chen, Taipei (TW); Bor-Ruey Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/345,589

(22) Filed: Jan. 16, 2003

(30) Foreign Application Priority Data
Jun. 21, 2002 (TW) 91113693

(51) Int. Cl. G06K 7/00

(52) U.S. Cl. 382/312

(57) ABSTRACT

An automatic measurement method for an auto-collimator. When a charge-coupled device catches the image of an object, the program performs image management detection. When the program finds obvious reflective spots in the captured image, the program initiates detection. The method obviates the need for operators to initiate measurement, shortening the measurement procedure and eliminating possible damage due to operator error.

### BACKGROUND OF THE INVENTION

1. Field of the Invention

The present invention relates to a measurement method for an auto-collimator, especially to an automatic measurement method for an auto-collimator.

2. Description of the Related Art

When an operator uses a related optical regulation machine to measure an object, the software will not execute without the operator activating an action switch.

FIG. 1 is a flowchart of the related optical regulation machine's measurement of an object, including is the steps of starting the software, transmitting an order to a charge-coupled device, using a charge-coupled device to capture an image of the object to be measured, and checking for activation of an action switch. If so, measurement is initiated, and, if not, returning to the capturing step.

As mentioned above, when using an auto-collimator to measure an object, the operator must activate the action switch to initiate measurement, time can be wasted if the operator ignores the switch activation step or activates the switch incorrectly.

### SUMMARY OF THE INVENTION

For this reason, there is a need for a method allowing automatic detection of whether the auto-collimator can initiate measurement. The method frees operators from having to initiate measurement.

To achieve this aim, the present invention requires operators to only place the object to be measured into the auto-collimator and activate the program to instruct the charge-coupled device to capture the image of the object. At the same time, the program performs image management detection. When the program finds obvious reflective spots is in the captured image, detection begins. The method obviates the need for operators to initiate measurement, not only shortening the measurement procedure, but also eliminating possible damage due to operator error.

One of the purposes of the present invention is to provide a method enable the program to find spots and execute measurement automatically. The operator needs only place and remove the object to be measured.

Another object of the present invention is to provide an automatic measurement procedure for an optical disk drive assembly or related optical devices.

### BRIEF DESCRIPTION OF THE DRAWINGS

FIG. 1 is a flowchart of a conventional measurement method for an auto-collimator;,and

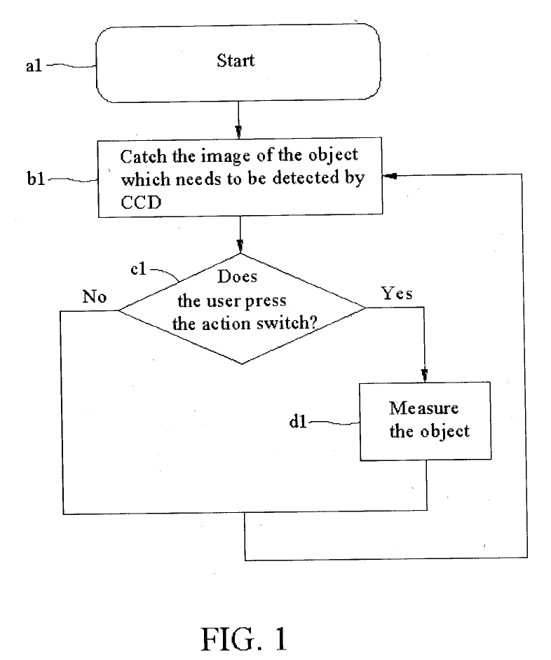

FIG. 2 is a flowchart of an automatic measurement method for an auto-collimator in accordance with the present invention.

### DETAILED DESCRIPTION OF THE INVENTION

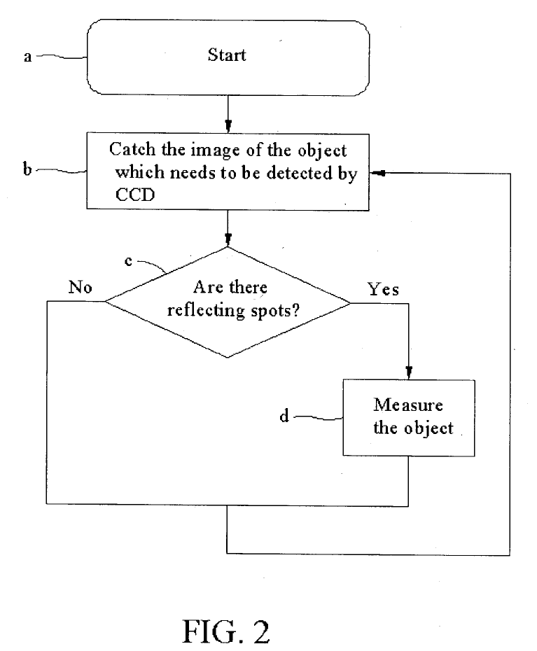

FIG. 2 is a flowchart of an automatic measurement method for an auto-collimator. The automatic measurement method for an auto-collimator allows the program to decide automatically if the auto-collimator can initiate measurement. The method includes the steps of starting the software, transmitting an order to a charge-coupled device to capture an image of the object to be measured, such that obvious reflecting spots in the captured image are detected. The program detects the reflecting spots automatically after capturing the image, being able to differentiate from the pre-placement absence of any reflected input. If spots are detected, the program initiates measurement automatically. If not, the program returns to the image capture step.

The captured image can be processed by image management to detect reflecting spots. There are many image management methods. One chooses a proper threshold value, and then acts thereon. After image management, the program can easily detect if there are white spot pixels whose grayscale value equals 255.

The object to be measured can be an object with a mirrored surface.

As mentioned above, the inventive method has the advantages of deciding automatically if the auto-collimator can begin measurement without relying on the judgment of an operator, shortening the measurement procedure, and avoiding the damage caused by mistimed or improper action on the part of the operator.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). therefore, the scope of the appended claims should be accorded the broadest interpretation so as to encompass all such modifications and similar arrangements.

What is claimed is:

1. An automatic measurement method for an auto-collimator, comprising the steps of:
using a charge-coupled device to capture an image of an object to be measured;
measuring the object when a reflecting spot is detected, and capturing the image of the object when no reflecting spot is detected.

2. An automatic measurement method for an auto-collimator as claimed in claim 1, wherein the reflecting spots are detected by image management.

3. An automatic measurement method for an auto-collimator as claimed in claim 1, wherein the auto collimator has optical measurement function, such that the auto-collimator can be used for measurement or fabrication of an optical disk drive assembly or related optical devices.

4. An automatic measurement method for an auto-collimator as claimed in claim 1, wherein the object to be measured is an object with a mirrored surface.
